(19) United States
(12) Patent Application Publication
(10) Pub. No.: US 2022/0193980 A1
(43) Pub. Date: Jun. 23, 2022

(54) SYSTEMS AND METHODS FOR PRINTING A THREE-DIMENSIONAL OBJECT

(71) Applicant: BRIGHAM YOUNG UNIVERSITY, Provo, UT (US)

(72) Inventors: Scott Lester Thomson, Provo, UT (US); Taylor Eugene Greenwood, Provo, UT (US); Serah Elizabeth Hatch, Provo, UT (US); Mark Bryan Colton, Provo, UT (US); Ryan Gregory Thomas Romero, Provo, UT (US); Clayton Adam Young, Provo, UT (US)

(21) Appl. No.: 17/601,771

(22) PCT Filed: Apr. 9, 2020
(86) PCT No.: PCT/US2020/027386

§ 371 Date: Oct. 6, 2021

Related U.S. Application Data
(60) Provisional application No. 62/831,844, filed on Apr. 10, 2019.
(60) Provisional application No. 62/859,600, filed on Jun. 10, 2019.

(51) Int. Cl. B29C 64/112; B29C 64/209; B29C 64/393

(52) U.S. Cl. CPC B29C 64/112; B33Y 10/00; B29C 64/393; B29C 64/209

(57) ABSTRACT

Systems and methods for printing a three-dimensional object are described. A method may include providing a support matrix having a base component and depositing an ink having the base component, a catalyst, and a cross-linker into the support matrix. The ink may be deposited into the support matrix in a predetermined pattern effective to form a plurality of layers of the ink. The support matrix supports the plurality of layers of the ink, and portions of the support matrix are disposed between at layers of the ink when the plurality of layers are formed in the support matrix. The method also may include solidifying or curing the ink deposited into the support matrix and also the portions of the support matrix deposited between the layers of the ink to form the three-dimensional object.

### CROSS-REFERENCE TO RELATED APPLICATIONS

This application claims priority to U.S. Provisional Application No. 62/831,844 filed on 10 Apr. 2019 and U.S. Provisional Application No. 62/859,600 filed on 10 Jun. 2019, the disclosures of which are incorporated herein, in their entirety, by this reference.

### BACKGROUND

Parts made from silicone are generally fabricated using traditional casting processes due to the silicone's low uncured viscosity. Examples include soft robots, external and implantable prostheses, biomimetic materials and tissue behavior analogues, MRI phantoms, and preoperative training models for surgical planning Custom parts for these types of applications are often created digitally using computer aided drafting (CAD) software and fabricated by indirect three-dimensional (3D) printing, where the positive molds are 3D printed from rigid materials and negative molds are created by casting around the positive molds. This fabrication process can be relatively inefficient and time-consuming, especially when dealing with unique geometries (e.g., for patient-specific models).

Silicone 3D printing is not yet commercially prevalent because some material properties of silicone cause challenges in 3D printing. Despite these inherent challenges, many processes are currently being developed for 3D printing silicone. Among these, extrusion printing processes are the most common, such as direct ink writing and embedded 3D printing.

### SUMMARY

Embodiments disclosed herein are related to systems and methods for printing a three-dimensional object. In an embodiment, a method includes providing a reservoir including a support matrix therein. The method also includes depositing at least one material in the support matrix in the reservoir in a predetermined pattern effective to form a plurality of layers of the at least one material. The support matrix supports the plurality of layers of the at least one material deposited therein and one or more portions of the support matrix are disposed between at least two layers of the plurality of layers of the at least one materials when the plurality of layers of the at least one material are formed in the support matrix. The method also includes at least partially solidifying the at least one material deposited into the support matrix and the one or more portions of the support matrix disposed between the at least two layers of the plurality of layers of the at least one material to form the three-dimensional object.

In an embodiment, a method of printing a three-dimensional object includes providing a reservoir including a support matrix therein. The method also includes depositing at least one ink having at least one catalyst and a cross-linker into the support matrix in the reservoir in a predetermined pattern effective to form a plurality of layers of the at least one ink. The support matrix supports the plurality of layers of the at least one ink deposited therein and one or more portions of the support matrix are disposed between at least two layers of the plurality of layers of the at least one ink when the plurality of layers of the at least one ink are formed in the support matrix. The method also includes at least partially solidifying the at least one ink deposited into the support matrix and the one or more portions of the support matrix disposed between the at least two layers of the plurality of layers of the at least one ink to form the three-dimensional object. The at least one catalyst and the cross-linker in the at least one ink promote bonding between the at least one ink and the one or more portions of the support matrix disposed between the at least two layers of the plurality of layers of the at least one ink. The method also includes removing at least a portion of the three-dimensional object from the support matrix.

In an embodiment, a system for printing three-dimensional objects includes one or more first reservoirs, a second reservoir, a printer, and a solidifying system. The one or more first reservoirs include at least one ink, at least one catalyst, and a cross-linker. The second reservoir includes a support matrix configured to support the at least one ink including the at least one catalyst and the cross-linker when the at least one ink is deposited into the support matrix. The printer is configured to inject the at least one ink including the at least one catalyst and the cross-linker into the support matrix held in the second reservoir in a predetermined pattern effective to form a plurality of layers of the at least one ink. One or more portions of the support matrix are disposed between at least two layers of the plurality of layers of the at least one ink when the plurality of layers of the at least one ink are formed in the support matrix. The solidifying system is configured to at least partially solidify the at least one ink deposited into the support matrix. The at least one catalyst and the cross-linker in the at least one ink promote bonding between the at least one ink and the one or more portions of the support matrix disposed between the at least two layers of the plurality of layers of the at least one ink to solidify the one or more portions of the matrix.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is an isometric view of a three-dimensional (3D) printer of a system for printing 3D objects, according to an embodiment.

FIG. 1B is a block diagram of a system for printing 3D objects, including the 3D printer and a solidifying system, according to an embodiment.

FIGS. 2A-2E are side views of ink injected into a support matrix, according to an embodiment.

FIGS. 3A-3D are side views of ink being injected into a support matrix during the printing of Y-shaped object, according to an embodiment.

FIG. 4 is a flowchart of a method for printing a 3D object, according to an embodiment.

FIG. 5A is a flowchart of a method for printing a 3D object, according to an embodiment.

FIG. 5B is a flowchart of a method for printing a 3D object, according to an embodiment.

FIG. 6 is a schematic of printing and tensile testing processes, according to an example.

FIGS. 7A-7C are images of a printed cube specimen used for measuring geometry and for tensile testing, according to an example.

FIGS. 8A-8G shows tensile testing setup and results, according to an example.

FIGS. 9A-9C are images of cube specimens during and after tensile testing, according to an example.

FIGS. 10A-10B are graphs of support matrix rheology testing, according to an example.

FIGS. 11A-11C are photographs of a cube printing process in support matrices with a dispersion of copper particles, according to an example.

FIGS. 12A-12E are photographs of prints fabricated from four silicone inks compared to shapes printed from PLA, according to an example.

FIG. 13 are photographs of printed shapes before trimming, according to an example

### DETAILED DESCRIPTION

Embodiments disclosed herein are related to systems and methods for printing a three-dimensional (3D) object. In conventional 3D printing, interior portions of the printed object can be devoid of ink between the layers and paths of the ink, which can undesirably alter material properties of the 3D printed object. In many of the systems and methods described herein, portions of the support matrix trapped or disposed between layers and paths of the ink bond with the ink when the ink is solidifying or curing, thereby providing a 3D-printed object having a substantially continuous, substantially unified solid.

Many systems and methods described herein include printing solid-infill shapes from soft silicone elastomers or other materials. As described in greater detail below, some embodiments of these systems and methods include using a removable-embedded 3D printing process where shapes are fabricated by extruding ink, such as silicone ink, on or within a selectively-curable support matrix and then at least partially curing the ink and the support matrix proximate to or interfacing the ink. Tensile testing indicated that 3D prints according to embodiments described herein exhibit a substantially isotropic elastic modulus in directions perpendicular and parallel to the printed layers, indicating strong material cohesion between printed paths, layers, and cured matrix. Shapes printed according to some of embodiments described herein include use of four silicone inks which, when printed into the support matrix and cured, range in elastic modulus from 5 kPa to 430 kPa and have failure strains about 50% to about 250%, thus suggesting a wide range of potential applications for the 3D printing systems and methods described herein.

In some embodiments, silicone-based elastomers are used in at least one of the support matrix or the ink injected into the support matrix during 3D printing. Silicone-based elastomers (e.g., silicone rubber, PDMS) are primarily composed of polydimethylsiloxane polymer chains, which give the material a relatively low elastic modulus and a high elongation at fracture. These and other material properties such as biocompatibility, robustness, and transparency make silicone a favorable material in many applications.

Parts made from silicone are generally fabricated using traditional casting processes due to the material's low uncured viscosity. Examples include soft robotics, external and implantable prostheses, biomimetic materials and tissue behavior analogues, MRI phantoms, and preoperative training models for surgical planning. In some applications, soft silicone may be used to create synthetic vocal fold models to study the biomechanics of voice production. Custom parts for these types of applications are often created digitally using CAD software and fabricated by indirect 3D printing, where the positive molds are 3D printed from rigid materials and negative molds are created by casting around the positive molds. This fabrication process can be relatively inefficient and time-consuming, especially when dealing with unique geometries (e.g., for patient-specific models).

Direct 3D printing can be a favorable alternative to casting because the process can be faster, more material-efficient, and potentially more versatile, especially when creating unique geometries. Silicone 3D printing is not yet commercially prevalent because some material properties of silicone, such as low uncured viscosity, relatively long cure time, and relatively low elastic modulus, cause challenges in 3D printing.

Removable-embedded 3D printing may fabricate ultrasoft prints of what has typically been created using casting-based fabrication processes. The removable-embedded process does not require modification of the low-viscosity silicone materials that are typically used (viscosity ranges of about 0.1 Pa·s to about 10 Pa·s), and is thus advantageous to processes such as direct ink writing. In some examples, modifying the ink in direct ink writing to have a sufficiently high viscosity increased the cured material stiffness beyond the desired range. Embedded 3D printing imposes undesired geometric constraints. While reference is made to silicone-based ink and support matrices, such references are non-limiting examples, and many embodiments include non-silicone-based materials in the ink and the support matrix, described in greater detail below.

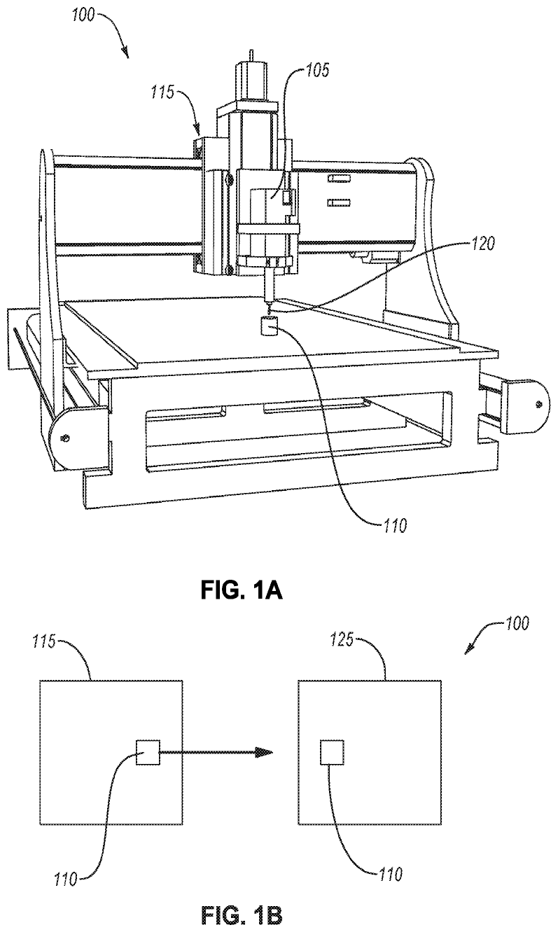

Turning to FIG. 1A, which shows a portion of a system 100 for printing a 3D object, according to an embodiment. The system 100 may include a 3D printer 115 configured to be coupled to a computer and receive instructions from a computer to print a predetermined pattern to form a 3D object. In many embodiments, the predetermined pattern is determined by computer coupled to the 3D printer 115. For example, a computer coupled to the 3D printer 115 may include a CAD program that allows a user to enter or develop a predetermined pattern in a CAD file. The CAD file on the computer may provide instructions for the 3D printer to inject the ink into the support matrix in the predetermined pattern. For example, the 3D printer and/or computer may include 3D slicing software configured to convert print geometry in from one format to a format suitable for the predetermined 3D pattern. The instructions also may include instruction for axis reset at the beginning of printing and dispenser retraction at the end of printing. The 3D printer may include one of various 3D printers, such as a 3-axis linear printer.

The system 100 also includes a reservoir 110 for holding a support matrix. The reservoir 110 may be separate and removably securable to the 3D printer 115. The 3D printer 115 includes a reservoir 105 for holding ink and a dispenser 120 for dispensing the ink from the reservoir 105 into the support matrix in the reservoir 110. In some embodiments, the 3D printer 115 includes a single reservoir 105 that includes ink mixed with one or more catalysts and a cross-linker. In some embodiments, the 3D printer 115 may include multiple reservoirs for holding the ink, the one or more catalysts, and the cross-linker. For example, the 3D printer 115 may include a reservoir for holding the ink, a reservoir for holding the one or more catalysts, and a reservoir for holding the cross-linker. In another example, the 3D printer may include a reservoir for holding the ink mixed with one of the one or more catalysts or the cross-linker and a different reservoir for holding a different one of the one or more catalysts or the cross-linker. In embodiments having the one or more catalysts or the cross-linker in a different reservoir than the ink, the ink is mixed with the one or more catalysts and the cross-linker before or simultaneous being injected into the support matrix.

The system 100 is configured to provide a removable-embedded 3D printing process in which printed ink, such as silicone ink, is extruded through the dispenser 120 into a secondary support matrix in the reservoir 110, which support matrix supports the ink during the printing and solidifying processes. In some embodiments, the dispenser 120 includes a needle, an ink jet print head, or other depositing device that injects or otherwise deposits the ink from the reservoir into the support matrix.

The support matrix held in the reservoir 110 and the ink held in the reservoir 105 may include any of a number of different materials. In many embodiments, the support matrix is configured to support the ink when the ink is injected into the support matrix. The support matrix may include a thickener configured to thicken the support matrix effective to support the ink. For example, fumed silica may be mixed with a silicone-based support matrix to thicken the support matrix. The thickener may be added at varying weight percents of support matrix, such as about 0.1 to about 20 wt % of the support matrix, about 0.5 to about 10 wt % of the support matrix, about 1 to about 5 wt % of the support matrix, about 1 to about 3 wt % of the support matrix, about 3 to about 5 wt % of the support matrix, about 5 to about 7 wt % of the support matrix, about 7 to about 9 wt % of the support matrix, about 1 wt % of the support matrix, about 2 wt % of the support matrix, about 3 wt % of the support matrix, about 4 wt % of the support matrix, about 5 wt % of the support matrix, about 6 wt % of the support matrix, about 7 wt % of the support matrix, about 8 wt % of the support matrix, about 9 wt % of the support matrix, or about 10 wt % of the support matrix. The thickener and the base material may be mixed until homogenous, and the support matrix also may be degassed before ink is injected into the support matrix. The support matrix may include, for example, a gel material.

Moreover, the support matrix may be configured such that at least a portion of the support matrix bonds to the ink injected into the support matrix when the ink is solidified or cured in the support matrix. For example, portions of the support matrix interfacing or in the immediate vicinity of the ink injected into the support matrix may bond with the ink that the portions of the support matrix interface when the ink is solidified or cured in the support matrix. In some embodiments, the reservoir 110 and the support matrix may both be transparent or translucent, thereby allowing light to reach the ink injected into the support matrix when the ink requires light for curing.

In many embodiments, both the support matrix and the ink include the same or identical base component or polymer. For example, the same silicone polymer may be included as the base in both the support matrix and the ink. In addition to the base component, the ink also may include both a catalyst and one or more cross-linkers. In some embodiments, the ink may include a water-based liquid or paste, and the support matrix may include a water-based support matrix. In some embodiments, the ink may include an oil-based liquid or paste and the support matrix may include and oil-based support matrix.

In some embodiments, the ink includes a silicone elastomer ink including a base combined with a catalyst. The ink also may include a thinner combined with the base and the catalyst. For example, the ink may include a UV-curable silicone or an addition-cure silicone (low-stiffness or high-stiffness) to which is added a silicone thinner. The ink may include varying base:catalyst ratios, such as a 15:1 base:catalyst ratio by weight. The ink also may include varying base+catalyst:thinner ratio to reduce the mixed viscosity and cured material stiffness, such as a 1:3 or 1:6 base+catalyst:thinner ratio by weight. The ink also may include a cross-linker pre-mixed with one of the base or the catalyst, or added separately from the base or the catalyst. The ink also may include a colorant and/or other additives, particles, fillers, and so forth. In many embodiments, the ink may be mixed until homogenous, and then degassed.

While examples are provided herein relating to silicone-based ink and support matrix, other compatible inks or materials and support matrices also could be used. In each of the examples provided, the ink and the support matrix may include the same or identical base component, and the ink may include a catalyst and a cross-linker. In some embodiments, the ink or other material deposited into the support matrix does not include a catalyst and a cross-linker, and the ink or other material deposited into the support matrix do not include the same base component. Some examples may include food applications such as an edible gelatin ink injected into a thickened water-based support matrix, an edible dough ink injected into a water-based support matrix or dough-like slurry support matrix, an edible frosting ink injected into a water- or milk-based slurry or support matrix, or an artificial meat ink injected into a water- or oil-based support matrix. Some examples may include one or more hydrogel or other biomaterials injected into a water-based support matrix or an extracellular matrix (ECM) ink injected into a water-based support matrix. Other polymer-based examples may include a foam ink injected into a compatible polymer-based support matrix, an epoxy ink injected into a compatible epoxy-based support matrix, or one or more polyurethane inks injected into a compatible support matrix. In some embodiments, a concrete ink may be injected into a concrete-based slurry support matrix. Other examples may include depositing ink filled with wood particles into a water-based or polymer-based support matrix, such as wood particles mixed with an epoxy ink and injected into an epoxy-based support matrix. In some embodiments, the ink may include an epoxy-based ink having a filler including one or more of metal, ceramic, plastic, rubber, or other organic and/or inorganic material that is injected into an epoxy-based support matrix.

Other examples may include depositing a metal-based ink into a metal-based support matrix having a lower melting temperature than the metal-based ink. This composition allows the metal-based ink and the metal-based support matrix to both be heated to a liquid state, and the removal of a solidified ink from a liquid support matrix as the ink hardens before the support matrix. Other examples may include depositing a glass-based ink into a glass-based support matrix having a lower melting temperature than the glass-based ink. This composition allows the glass-based ink and the glass-based support matrix to both be heated to a liquid state, and the removal of a solidified ink from a liquid support matrix as the ink hardens before the support matrix.

In many embodiments, the catalyst and the cross-linker in the ink correspond to the base of the ink. For example, in an ink including a silicone base, the catalyst may include an ultraviolet (UV)-curing liquid silicone rubber (LSR) catalyst. In some examples, the ink may include addition-cure silicone having platinum that is used to catalyze the silicone during curing. In some examples, the ink includes room-temperature-vulcanizing (RTV) silicone. In some examples, the ink may include condensation-cure silicone having one or more mechanisms, which catalyze the silicone during curing. These mechanisms that catalyze the silicone during curing may include one or more of acetoxy, oxime, alkoxy, or acetone. In some example, the ink may include multiple types of silicone which can be cured in multiple curing techniques.

Turning to FIG. 1B, which shows a block diagram of the system 100 including the 3D printer 115 and a solidifying system 125. Although shown separately in FIG. 1B, the 3D printer 115 and the solidifying system 125 may be included in a single unit. In some examples, the reservoir 110 containing the support matrix and the ink may be moved from the 3D printer 115 to the solidifying system 125. The solidifying system 125 is configured to cause the catalyst in the ink to solidify the ink. The solidifying system 125 may include, for example, a curing system such as an UV-curing system (such as UV curing bed) configured to cure UV-curable ink via photocatalysts in the ink. In some embodiments, the system 100 includes printing a UV-curable silicone within a micro-organogel support matrix. Other examples of solidifying systems may include any system configured to solidify or cure the ink, such as heat, light, a laser, a heat lamp, condensation (curing in the presence of water in the air), and so forth. In some examples, the ink may solidify or cure with time. Solid-infill prints may be fabricated and subjected to tensile testing to determine the elastic modulus in directions perpendicular and parallel to the printed layers.

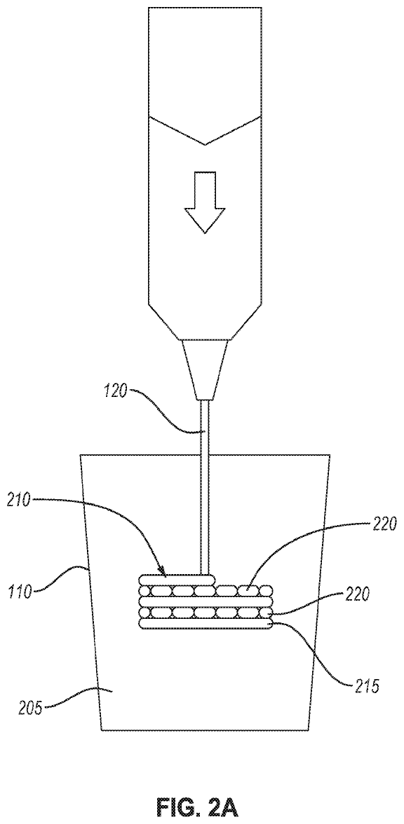

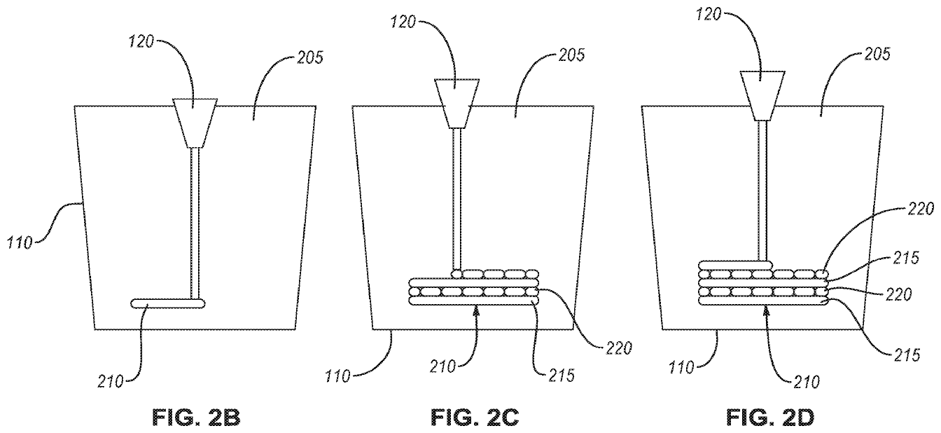

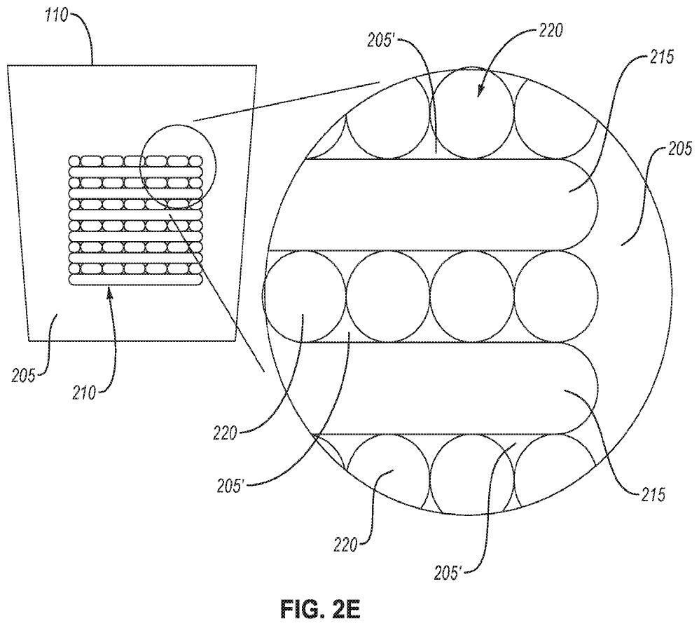

FIGS. 2A-2E show side views of the reservoir 110 holding a support matrix 205 therein and various stages of the dispenser 120 of the 3D printer 115 depositing ink 210 into the support matrix 205. The support matrix 205 and the ink 210 may include any of the support matrices and compatible inks described above. The support matrix 205 is configured to allow the dispenser 120 to pass through the through support matrix 205 and inject or extrude the ink 210 into the support matrix 205. The ink 210 may be injected into the support matrix 205 in the predetermined pattern that forms a plurality of layers 215 each include one or more paths 220 of the ink 210. The dispenser 120 may alternate the direction of the paths 220 in each adjacent layer 215. For example, the dispenser 120 may inject ink 210 in a first layer in one or more paths 220 in a first direction, then inject ink 210 in a second layer adjacent to the first layer in one or more paths 220 in a second direction that is angled (such as 90°) from the first direction.

Turning specifically to FIG. 2E, the system 100 and methods described herein may fabricate thick-walled and solid-infill prints that contain small inclusions of uncured portions 205′ of the support matrix 205 trapped or disposed between adjacent layers 215 of the ink. The trapped, uncured portions 205′ of the support matrix are undesirable because the trapped, uncured portions 205′ of the support matrix 205 alter the material properties of the print due to poor material adhesion and a non-homogeneous material distribution. Adjusting print settings to reduce the amount of trapped portions 205′ of the support matrix material 205 can result in distended shapes with poor geometry and resolution, and removing the trapped portions 205′ of the support matrix 205 is challenging or impossible. During or after printing, the printed layers 215 and paths 220 may or may not remain in their originally deposited locations. In some embodiments, the layers 215 and paths 220 may be mixed by motion within the support matrix 205 and printed structure. This mixing motion may cause or promote the printed ink 210 to mix with the portions 205′ of the support matrix 205. Accordingly, in some embodiments, the portions 205′ of the support matrix 205 may be at least partially mixed within the ink 210 before the ink 210 is solidified or cured. In some embodiments, however, the portions 205′ of the support matrix 205 remain unmixed with the ink 210 before the ink 210 is solidified or cured.

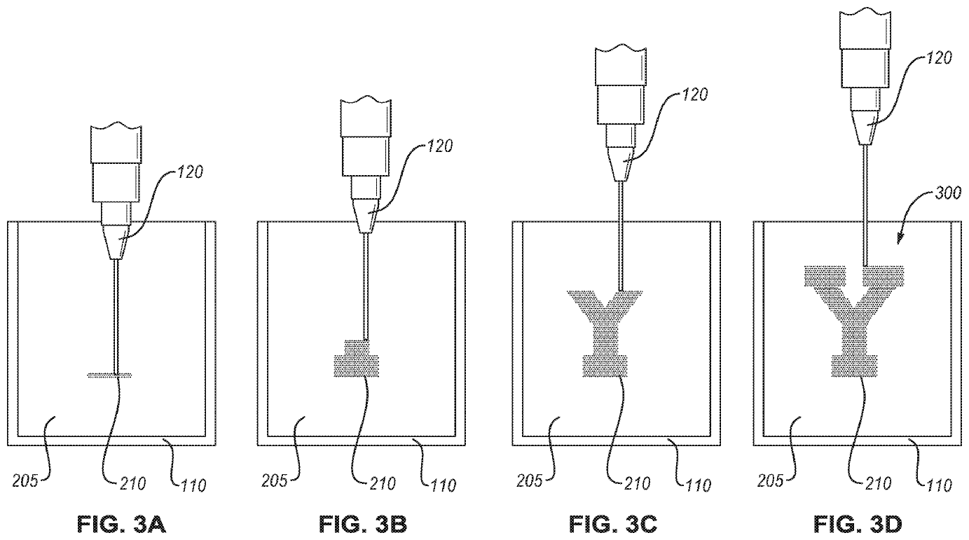

To allow the support matrix 205 to be around and within the pattern of ink 210 and support the pattern of ink, and also have the trapped portions 205′ of the support matrix 205 absent from the final object, the support matrix 205 is formulated to support the pattern of ink 210 during the printing process and solidify or cure within the printed pattern during solidifying or curing, thereby yielding solid printed objects with no uncured material within the solidified printed object. For example, when the support matrix 205 and the ink 210 have the same base component, such as the same silicone polymer, the trapped portions 205′ of the support matrix 205 in the voids between the layers 215 and/or the paths 220 may bond with the ink 210 that includes the cross-linker and the catalyst. This bonding between the trapped portions 205′ of the support matrix 205 and the ink 210 may occur when the ink is solidified or cured, and allows the trapped portions 205′ of the support matrix 205 to be solidified or cured, sometimes simultaneously, with the ink 210. The trapped portions 205′, then, become a continuous, unified solid with the ink 210 in the final object after curing. Accordingly, the support matrix 205 may be referred to as a selectively-solidifiable or selectively-curable support matrix 205 that supports the ink 210 during printing then solidifies cures within the printed ink structure. FIG. 3A-3D provide side views using the ink 210 to print a 3 cm-tall “Y” shape in the support matrix 205, as an example.

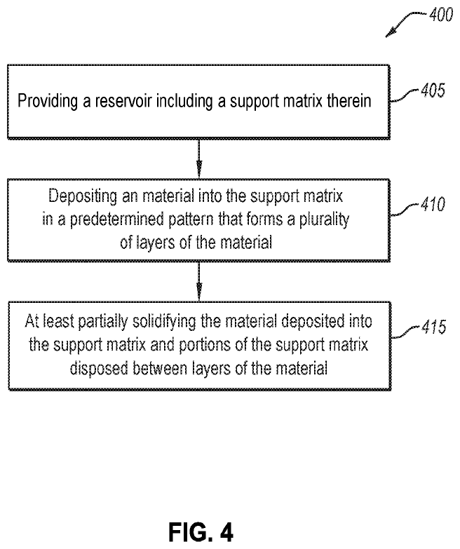

FIG. 4 is a flowchart of a method of forming a 3D object, according to an embodiment. The method 400 includes an act of providing a reservoir including a support matrix therein. The method 400 also may include an act 410 of depositing a material in a predetermined pattern that forms a plurality of layers of the material. The method 400 also may include an act 415 of solidifying the material deposited into the support matrix and portions of the support matrix disposed between layers of the material. Acts 405, 410, and 415 of the method 400 are for illustrative purposes. For example, acts 405, 410, and 415 of the method 400 may be performed in different orders, split into multiple acts, modified, supplemented, or combined. Any of the acts 405, 410, and 415 may include using any of the systems disclosed herein, such as the system 100.

The act 405 includes providing a reservoir including a support matrix therein. The support matrix may include any of the support matrices described herein. For example, the support matrix may include a water-based support matrix, an oil-based support matrix, a dough-like slurry support matrix, a milk-based slurry support matrix, an epoxy-based support matrix, a concrete-based slurry support matrix, a polymer based support matrix, a metal-based support matrix, a glass based support matrix, or combinations thereof.

The act 410 includes depositing a material in a predetermined pattern that forms a plurality of layers of the material. More specifically, the act 410 may include depositing at least one material in the support matrix in the reservoir in a predetermined pattern effective to form a plurality of layers of the at least one material. The support matrix supports the plurality of layers of the at least one material deposited therein and one or more portions of the support matrix are disposed between at least two layers of the plurality of layers of the at least one materials when the plurality of layers of the at least one material are formed in the support matrix.

The material deposited in the support matrix in the act 410 may include any of the materials described herein. For example, the material may include an ink deposited into the support matrix. The act 410 may, according to various embodiments, include a water-based liquid or paste material deposited into a water-based support matrix, an oil-based liquid or paste material deposited into an oil-based support matrix, a silicone elastomer ink material including a base combined with a catalyst deposited into a support matrix include the same base, an edible gelatin material deposited into a thickened water-based support matrix, an edible dough material deposited into a water-based support matrix or dough-like slurry support matrix, an edible frosting material deposited into a water- or milk-based slurry or support matrix, or an artificial meat material deposited into a water- or oil-based support matrix, one or more hydrogel or other biomaterials deposited into a water-based support matrix, an ECM material deposited into a water-based support matrix, a foam material deposited into a compatible polymer-based support matrix, an epoxy material deposited into a compatible epoxy-based support matrix, or one or more polyurethane material deposited into a compatible support matrix, a concrete material deposited into a concrete-based slurry support matrix, material filled with wood particles deposited into a water-based or polymer-based support matrix, wood particles mixed with an epoxy material deposited into an epoxy-based support matrix, an epoxy-based material having a filler including one or more of metal, ceramic, plastic, rubber, or other organic material deposited into an epoxy-based support matrix, a metal-based material deposited into a metal-based support matrix having a lower melting temperature than the metal-based material, a glass-based material deposited into a glass-based support matrix having a lower melting temperature than the glass-based ink, or combinations thereof.

The method 400 also includes the act 415 of solidifying the material deposited into the support matrix and portions of the support matrix disposed between layers of the material. More specifically, the act 415 may include at least partially solidifying the at least one material deposited into the support matrix and the one or more portions of the support matrix disposed between the at least two layers of the plurality of layers of the at least one material to form the 3D object.

In one or more embodiments, both the material and the portions of support matrix trapped or disposed between layers of the material may be solidified at the same time and/or via the same process. Once both the material and the portions of the support matrix trapped or disposed between layers of the material are solidified, the 3D object may be removed from the remaining support matrix. Accordingly, the act 415 includes simultaneously at least partially solidifying both the material deposited into the support matrix and the portions of the support matrix disposed between the layers of the material to form the 3D object. In more specific embodiments, the act 415 may include simultaneously at least partially curing both the material deposited into the support matrix and the portions of the support matrix disposed between the layers of the material to form the 3D object.

For example, in some embodiments, the at least one material includes at least one cross-linker and at least one catalyst. The at least one cross-linker and the at least one catalyst promote bonding between the at least one ink and the one or more portions of the support matrix disposed between the at least two layers of the plurality of layers of the at least one material when the at least one material is cured effective to simultaneously at least partially cure both the at least one material deposited into the support matrix and the one or more portions of the support matrix disposed between the at least two layers of the plurality of layers of the at least one material to form the 3D object.

In some embodiments, the material deposited in the support matrix may be at least partially solidified and then removed from the support matrix. In these and other embodiments, the portions of support matrix trapped or disposed between layers of the material may be at least partially solidified after the at least partially solidified material has been removed from the support matrix. According to some aspects of the method 400, solidifying of the material deposited into the support matrix and portions of the support matrix trapped or disposed between layers of the material do not require chemical bonding between the trapped portions of the support matrix and the layers of the material. For example, in some embodiments, at least one of the material deposited into the support matrix and portions of the support matrix trapped or disposed between layers of the material may be solidified via a phase change, e.g., without a catalyst and/or a cross-linker in the material deposited into the support matrix.

Accordingly, the act 415 may include at least partially solidifying the at least one material deposited into the support matrix and at least partially solidifying the one or more portions of the support matrix disposed between the at least two layers of the plurality of layers of the at least one material after the at least one material deposited into the support matrix has been solidified. Some embodiments also may include at least partially solidifying the at least one material deposited into the support matrix via a first process and at least partially solidifying the one or more portions of the support matrix disposed between the at least two layers of the plurality of layers of the at least one material via a second process that is different than the first process.

In an embodiment, the first process may include at least partially curing the material at a first wavelength, and the second process may include at least partially curing the one or more portions of the support matrix disposed between the at least two layers of the material at a second wavelength that is different than the first wavelength. For example, the method 400 may include printing an ink material in a support matrix that cures at a different wavelength than the ink material. According to some example, a UV-cure silicone ink may be selected that cures at a different wavelength than a UV-cure polyurethane support matrix. The UV-cure silicone ink may be deposited into the UV-cure polyurethane support matrix. The UV-cure silicone ink may then be cured using a first UV wavelength effective cure the UV-cure silicone ink in the support matrix, while the UV-cure polyurethane support matrix remains uncured. The cured UV-cure silicone ink is then removed from the UV-cure polyurethane support matrix, with the cured UV-cure silicone ink include trapped portions of the UV-cure polyurethane support matrix between layers of the cured UV-cure silicone ink. Once removed from the support matrix, the cured UV-cure silicone ink and the trapped portions of the UV-cure polyurethane support matrix between layers of the cured UV-cure silicone ink may be subjected to a second UV wavelength that is different than the first UV wavelength, effective to cure the trapped portions of the UV-cure polyurethane support matrix between layers of the cured UV-cure silicone ink. The final object, then is a 3D object include cured silicone and cured polyurethane.

In an embodiment, the first process may include at least partially solidifying the material over a first time period, and the second process may include at least partially solidifying the one or more portions of the support matrix disposed between the at least two layers of the material at a second time period that is different than the first time period. For example, the method 400 may include forming a 3D object with materials having different solidification times, such as printing one type of glue material into another type of glue support matrix. In this example, a reservoir may be filled with first glue that solidifies over a first time period or duration of time. A second glue which solidifies over a second time period or duration of time that is less than the first time period may be deposited into the support matrix of the first glue. The second glue may, for example, include a hot glue. The second glue may solidify in the first glue support matrix during or shortly after deposition therein, and the at least partially solidified second glue may be removed from the reservoir of the first glue support matrix. When removed, the at least partially solidified second glue includes trapped portions of the unsolidified first glue support matrix. Over a time, the trapped portions of the first glue support matrix in the at least partially solidified second glue material will also at least partially solidify, leaving a 3D object having two glues adhered to one another to form an at least partially solid composite shape.

In another example, the method 400 may include printing a material into a support matrix that has a different solidification temperature than the material. In these and other example, both the material and the support matrix may be above requisite solidification temperatures for the material and the support matrix. Examples may include metals, plastic, or glass. In an example, the support matrix has a melting point temperature of T1 that is lower than the melting point T2 (and solidification point) of the ink material. Both the support matrix and the ink material may be heated to a liquid state or liquid-like state, and the support matrix deposited into the reservoir (before or after heating to the liquid state or liquid-like state). The ink material may then be deposited into the support matrix, keeping both the support matrix and the ink material above T2 so both the support matrix and the ink material are flowable. The reservoir including the support matrix and the ink material may then be cooled to a temperature below T2 but above T1. Cooling to a temperature in this range solidifies the ink material, while the support matrix remains liquid. Once the ink material is solidified and before the support matrix solidifies, the solidified ink material may be removed from the support matrix, with the solidified ink material including trapped portions of the support matrix between solidified layers of the ink material. After removal, the solidified ink material may be cooled below T1, such that the trapped portions of the support matrix also solidify, resulting in a 3D object.

In an embodiment, the first process may include at least partially solidifying the material at a first temperature, and the second process may include at least partially solidifying the one or more portions of the support matrix disposed between the at least two layers of the material at a second temperature that is different than the first temperature. For example, the method 400 may include forming a 3D dough object into a gelatin support matrix. In this example, a reservoir may be filled with a liquid gelatin and a dough material may be deposited into the liquid gelatin in the reservoir. Once the liquid gelatin is deposited into the support matrix of liquid gelatin, the reservoir (including the dough and the liquid gelatin) may be heated or baked. During this heating or baking, the gelatin remains a liquid, but the dough at least partially solidifies. After heating or baking, the reservoir may be removed from the heat source and allowed to cool at room temperature. The at least partially solidified (baked) dough material may then be removed from the reservoir of the support matrix of the liquid gelatin, with the at least partially solidified dough including trapped portions of gelatin therein. The at least partially solidified dough material may then be placed into a cooler environment, such as a refrigerator, effective to at least partially solidify the gelatin trapped between layers of the now at least partially solidified dough. Once cooled in the refrigerator effective to at least partially solidify the gelatin trapped in the at least partially solidified dough, the object may be removed from the refrigerator, the object including two kinds of food products which adhere to one another to form a solid composite shape.

In an embodiment, the first process may include at least partially solidifying the material with at least one of a first light wavelength, a first time period, or a first temperature. The second process may include at least partially solidifying the one or more portions of the support matrix disposed between the at least two layers of the material with at least one of a second light wavelength, a second time period, or a second temperature. For example, the first process may include solidifying the material with a particular light wavelength and the second process may include solidifying the one or more portions of the support matrix disposed between the at least two layers of the material over a period of time and/or at a certain temperature.

In some embodiments, the method 400 also includes removing the at least one material from the support matrix after the at least one material has been at least partially solidified and before at least partially solidifying the one or more portions of the support matrix disposed between the at least two layers of the plurality of layers of the at least one material.

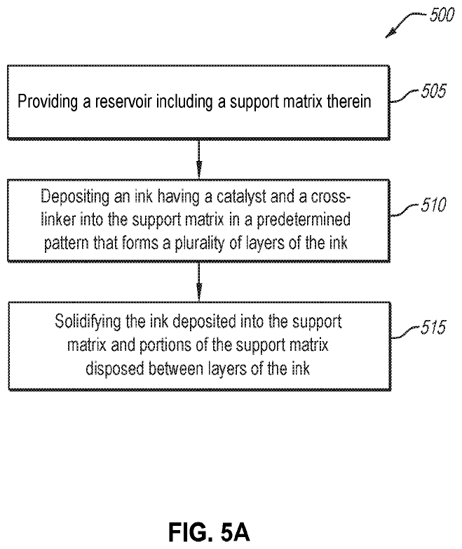

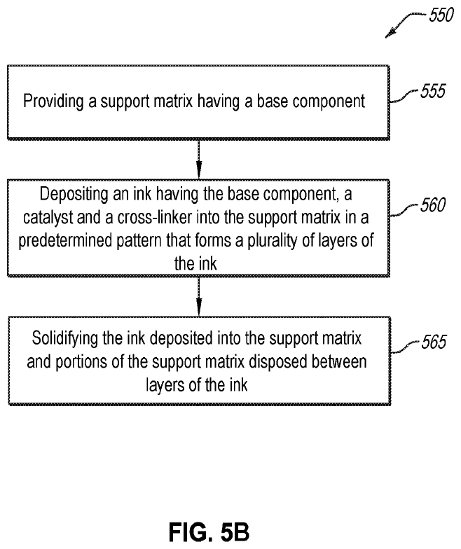

FIG. 5A is a flowchart of a method 500 of printing a 3D object, according to an embodiment. The method 500 may include an act 505 of providing a reservoir including a support matrix therein. The method 500 also may include an act 510 of depositing an ink having a catalyst and a cross-linker into the support matrix in a predetermined pattern that forms a plurality of layers of the ink. The method 500 also may include an act 515 of solidifying the ink injected into the support matrix and portions of the support matrix disposed between layers of the ink. Acts 505, 510, and 515 of the method 500 are for illustrative purposes. For example, acts 505, 510, and 515 of the method 500 may be performed in different orders, split into multiple acts, modified, supplemented, or combined. Any of the acts 505, 510, and 515 may include using any of the systems disclosed herein, such as the system 100.

The act 505 includes providing a reservoir including a support matrix therein. The support matrix may include any of the support matrices described herein. In many embodiments, the reservoir and the support matrix are transparent or translucent. In some embodiments, the method 505 can include formulating the support matrix to be clear.

The method 500 also may include an additional act of preparing the support matrix by mixing a liquid with a thickener. For example, the method 500 may include mixing an oil, such as silicone oil, with fumed silica. The fumed silica may be added at 3 wt % to the silicone oil and mixed before having bubbles removed by vibration. The method 500 also may include inserting the support matrix into the reservoir.

The act 510 includes depositing or injecting an ink having a catalyst and a cross-linker into the support matrix in a predetermined pattern that forms a plurality of layers of the ink. In some embodiments, the act 510 includes depositing or injecting at least one ink having at least one catalyst and a cross-linker into the support matrix in the reservoir in a predetermined pattern that forms a plurality of layers of the at least one ink each having one or more paths of the at least one ink. The support matrix supports the plurality of layers of the at least one ink injected therein, and one or more portions of the support matrix are trapped or disposed between at least two layers of the plurality of layers of the at least one ink when the plurality of layers of the at least one ink are formed in the support matrix. In some embodiments, the act 510 includes extruding the at least one ink through a dispenser (such as a needle) as the dispenser translates through the support matrix in the predetermined pattern that forms the plurality of layers of the at least one ink each having one or more paths of the at least one ink.

In some embodiments, the liquid of the support matrix includes a base component, such as a base polymer, and the at least one ink includes the same or identical base component. For example, the support matrix and the ink may include the same base material of silicone oil. Accordingly, in some embodiments, preparing the support matrix by mixing the liquid with the thickener includes preparing the support matrix by mixing silicone oil with the thickener that includes fumed silica, and the at least one ink includes a silicone ink including the at least one catalyst and the cross-linker.

In some embodiments, the method 500 also includes preparing the ink. The ink may be prepared by mixing the base with a catalyst and one or more additional materials. For example, the method 500 may include mixing UV-curable silicone rubber with a low-viscosity silicone oil at a 14:1:45 (base:catalyst:oil) ratio by weight. This mixture may decrease the cured stiffness of the final printed 3D object. In some embodiments, the cross-linker may be added to the mixture of the base, catalyst, or oil, and/or may already be included in the base, catalyst, or oil. In some embodiments, the method 500 includes adding fumed silica to the ink to improve resolution and decrease defects in the ink structure by giving the ink a yield stress and a shear-thinning viscosity.

The act 515 includes at least partially solidifying the ink injected into the support matrix and portions of the support matrix disposed between layers of the ink. More specifically, the act 515 may include at least partially solidifying the at least one ink injected into the support matrix and the one or more portions of the support matrix disposed or trapped between the at least two layers of the plurality of layers of the at least one ink to form the 3D object. One or more of the at least one catalyst and the cross-linker in the at least one ink promote bonding between the at least one ink and the one or more portions of the support matrix disposed or trapped between the at least two layers of the plurality of layers of the at least one ink during solidifying or curing of the at least one ink. Once solidified, then, the ink and the one or more portions of the support matrix trapped between the layers and/or the paths of the ink may become a substantially continuous, unified solid object.

In many embodiments, the act 515 includes at least partially solidifying the ink injected into the support matrix and portions of the support matrix disposed between layers of the ink to a selected level. For example, both the ink and the portions of the support matrix disposed between layers of the ink may be at least about 25% solidified, at least about 50% percent solidified, at least about 75% solidified, at least about 90% solidified, or about 100% solidified. In some embodiments, the one of the ink or the portions of the support matrix disposed between layers of the ink may be solidified to different levels. For example, the ink may be more solidified than the portions of the support matrix disposed between layers of the ink, such as the ink being at least about 90% or about 100% solidified and the portions of the portions of the support matrix disposed between layers of the ink being at least 50% or at least about 75% solidified.

The act 515 of at least partially solidifying the at least one ink injected into the support matrix may include any of a number of different at least partial solidifying acts, such as curing the at least one ink injected into the support matrix and/or heating the at least one ink injected into the support matrix. At least partially curing the at least one ink injected into the support matrix may include UV curing the at least one ink injected into the support matrix. For example, the act 515 may include placing the reservoir including the support matrix and the injected therein into an UV curing bed for a predetermined amount of time. The reservoir and the support matrix may include enough transparency to allow the UV light to pass through the reservoir and the support matrix and react with the photocatalyst in the ink. In other embodiments, other forms of light may be used to react with a catalyst in the ink to cure the ink. As curing action propagates throughout the ink structure in the support matrix, cross-linkers in the ink also form bonds with nearby base material in the support matrix, such as silicone polymers. Thus, the portions of the support matrix disposed between layers and/or paths of the ink become cured with the ink.

The method 500 also may include removing the 3D object from the support matrix. Removal of the 3D object from the support matrix can include acts in which the support matrix surrounding the print is separated from the at least partially solidified 3D object. In some embodiments, a removal device such as a spoon, spatula, or some combination thereof may be used to scoop and lift the 3D object out of the support matrix within the reservoir. In some embodiments, a tweezers or tongs may be used to grip the 3D object and pull it from the unsolidifed support matrix. The 3D object also may be removed from the support matrix by pouring the support matrix and the 3D object onto a sieve, with the support matrix passing through the sieve and the 3D object not passing through the sieve. The method 500 also may include cleaning the 3D object. Cleaning the 3D object may, for example, including rubbing or dabbing the 3D object with a cloth or paper towel. In some embodiments, a solvent such as acetone may be used to clean and/or rinse the 3D object. Other liquids, such as soap and/or water, may be used to clean and/or rinse the 3D object.

Careful removal of the well-structured 3D object leaves little to no residue in the support matrix, allowing the remaining support matrix to be reused with little risk of contamination from remaining cured ink. Accordingly, the method 500 also may include depositing additional ink into the support matrix after removing the 3D object from the support matrix to reuse the support matrix. Acts 510 and 515 may then be repeated.

In some embodiments of the method 500 described herein, a silicone ink containing silicone base polymers, catalyst(s) and cross-linkers is extruded into a support matrix made from silicone oil (i.e., silicone base polymers) and a rheological modifier. In contrast to conventional printing systems, many embodiments of the method 500 described herein can use a wider range of inks with the optional inclusion of filler particles within the ink and support matrix, allowing for more flexibility and customization.

FIG. 5B is a flowchart of a method 550 of printing a 3D object. The method 550 includes an act 555 of providing a support matrix having a base component. The method 550 also includes an act 560 of depositing an ink having the base component, a catalyst and a cross-linker into the support matrix in a predetermined pattern that forms a plurality of layers of the ink. The method 550 also includes an act 565 of solidifying the ink injected into the support matrix and portions of the support matrix disposed between layers of the ink. Acts 555, 560, and 565 of the method 550 are for illustrative purposes. In an embodiment, one or more of the acts 555, 560, and 565 of the method 550 may be omitted from the method 550. Any of the acts 555, 560, and 565 may include using any of the systems disclosed herein, such as the system 100. Furthermore, unless otherwise noted, any of the acts and features of the methods 400 and/or 500 may be included in the method 550.

The method 550 includes the act 555 of providing a support matrix having a base component. In some embodiments, the method 550 also includes an act of preparing the support matrix by mixing a liquid including the base component with a thickener, with the base component including a base polymer.

The method 550 also includes the act 560 of depositing or injecting an ink having the base component, a catalyst and a cross-linker into the support matrix in a predetermined pattern that forms a plurality of layers of the ink. More specifically, the act 560 can include depositing or injecting at least one ink having the base component, at least one catalyst and a cross-linker into the support matrix a predetermined pattern that forms a plurality of layers of the at least one ink each having one or more paths of the at least one ink. The support matrix supports the plurality of layers of the at least one ink injected therein and one or more portions of the support matrix are trapped between at least two layers of the plurality of layers of the at least one ink when the plurality of layers of the at least one ink are formed in the support matrix. The base component may include a base polymer that is the same or identical to the base polymer of the support matrix.

The method 550 also includes the act 565 of solidifying the ink injected into the support matrix and portions of the support matrix disposed between layers of the ink. More specifically, the act 565 may include solidifying the at least one ink injected into the support matrix and the one or more portions of the support matrix trapped or disposed between the at least two layers of the plurality of layers of the at least one ink to form the 3D object. The at least one catalyst and the cross-linker in the at least one ink promote bonding between the at least one ink and the one or more portions of the support matrix trapped or disposed between the at least two layers of the plurality of layers of the at least one ink. In some embodiments, the act 565 includes curing the at least one ink injected into the support matrix. In some embodiments, curing the at least one ink injected into the support matrix includes UV curing the at least one ink injected into the support matrix.

In many embodiments, the method 500 also includes removing the 3D object from the support matrix. After the 3D object has been removed, the method 500 also may include depositing additional ink into the support matrix after removing the 3D object from the support matrix to reuse to the support matrix.

The following working examples provide further detail in connection with the specific embodiments described above.

### Working Example 1

Support Matrix Preparation

The support matrix was prepared by adding fumed silica (Ure-Fil 9, Smooth-On) at 3.0 wt. % to silicone oil (Silicone Thinner, Smooth-On), mixing for 4 minutes at 2000 rpm until homogeneous using a planetary centrifugal mixer (DAC 150.1 FVZ-K SpeedMixer, FlackTec), and then vacuum degassing for approximately 2 minutes using a vacuum pump (Pittsburgh) and vacuum chamber (ThermoScientific).

Ink Preparation

The silicone ink used to print the test specimens is described below, while the other three inks used for demonstration prints are described in Example 2. The test specimen ink was prepared by combining the base and catalyst of a UV-curable silicone (Momentive UV Electro 225-1) at a 15:1 (base:catalyst) ratio by weight, then adding Silicone Thinner at a 1:3 (base+catalyst:Thinner) ratio by weight to decrease the mixed viscosity and cured material stiffness. The ink was colored by adding approximately 0.01 wt. % pigment (SilcPig, Smooth-On) before mixing. These components were mixed at 2000 rpm for 2 minutes until homogeneous then vacuum degassed for approximately 2 minutes and subsequently loaded into a plastic 3 ml syringe (CareTouch).

Printing Process

The printer was made from a 3-axis linear CNC mill (Zen Toolworks), retrofitted with a custom extruder. Print geometry in STL format was converted into G-code using a 3D slicing software (Cura). Next, the G-code was modified by adding instructions to reset all axis locations at the beginning of the print and instructions to vertically retract the needle from the reservoir of the support matrix once printing was complete (approximately 3 lines of code). The G-code was then loaded into the printer control software (Mach3).

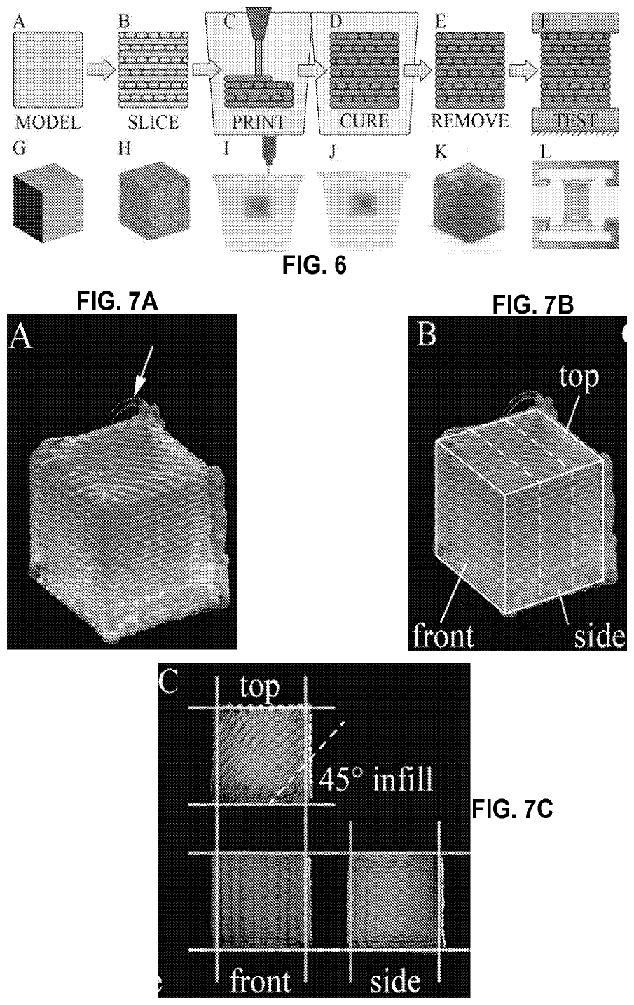

Before printing began, an ink-filled syringe was affixed with a stainless-steel dispensing needle (Jensen Global) and loaded into the extruder. A reservoir was filled with support matrix and secured to the print bed. Next, the needle tip was positioned at the desired start location near the inside bottom of the reservoir. During printing, ink was extruded through the needle as it translated through the support matrix following instructions contained in the G-code (see, for example, FIGS. 2B and 3A). FIG. 6 also shows a summary of printing and tensile testing processes, with labeled illustrations (A-F) and corresponding screenshots and images (G-L). In the printing process shown in FIG. 6, a 3D model of the desired shape is generated (A,G), “sliced” into print control instructions (“G-code”) according to a set of print settings (B,H), printed within the selectively-curable support matrix (C,I), cured within the support matrix (D,J), then removed and cleaned (E,K). The print is then mounted between plates and subjected to tensile testing (F,L).

Print Settings & Performance

Printing was performed using a 25G blunt-tip dispensing needle (0.26 mm ID, 0.52 mm OD, 38 mm-long, Jensen Global). Select print settings modified in the slicing software (Cura) for creating the tensile test specimens are included in Table 1, below. Print performance was evaluated by measuring the top, front, and side faces of 12 printed cube specimens under a microscope (Leica Microsystems, M125C), observing the surface resolution of each face, and subjecting the cubes to tensile tests (discussed in greater detail below).

TABLE 1
Select print settings which were modified in the slicing software
(Cura) for creating the printed tensile-test specimens.

| Print Setting | Value |
|---|---|
| Layer Height | 0.26 mm |
| Nozzle Diameter | 0.26 mm |
| Infill Density | 60% |
| Infill Pattern | 45° Rectilinear |
| Perimeters | See note |
| Filament Diameter | 8.66 mm |
| Print Speed | 24 mm/s |
| Travel Speed | 24 mm/s |

Ink Curing and Removal

After printing, the reservoir was placed inside a UV curing bed (Dreve Polylux 2000) for several minutes to cure the printed silicone ink. During this process, the selectively-curable support matrix also solidified within the print. As documented and described below in the Cured Print Tensile Tests and the Support Matrix Curing Tests, the curing of the support matrix was verified by tensile testing results, observing the surface of prints, and observing the inner mid-sections of cut-apart cured prints. Once cured, the print was removed from the support matrix and gently cleaned. It was observed that careful removal of well-structured prints left no cured ink residue within the reservoir, allowing the remaining support matrix to be reused with little risk of defects from remaining ink.

Cured Print Tensile Tests

Tensile testing was performed on 12 printed and six cast specimens fabricated from the same batch of silicone ink using a procedure and analysis for testing similar 3D-printed specimens. The geometry for tensile test specimens was a 1×1×1 cm cube. FIG. 7A-7C are images of a printed cube specimen used for measuring geometry and for tensile testing. FIG. 7A is an image of an isometric view of a printed cube, with an arrow that indicates the ‘tail’ of silicone which is deposited as the needle retracts vertically from the support matrix after printing is complete. FIG. 7B is an image of an overlay showing the edges of the cube (solid lines) and the approximate locations where prints were cut (dashed lines) to create the mid-sections for imaging. FIG. 7C is an image of top, front, and side faces of the printed cube. Lines are spaced 10 mm apart to show the print's dimensional accuracy.

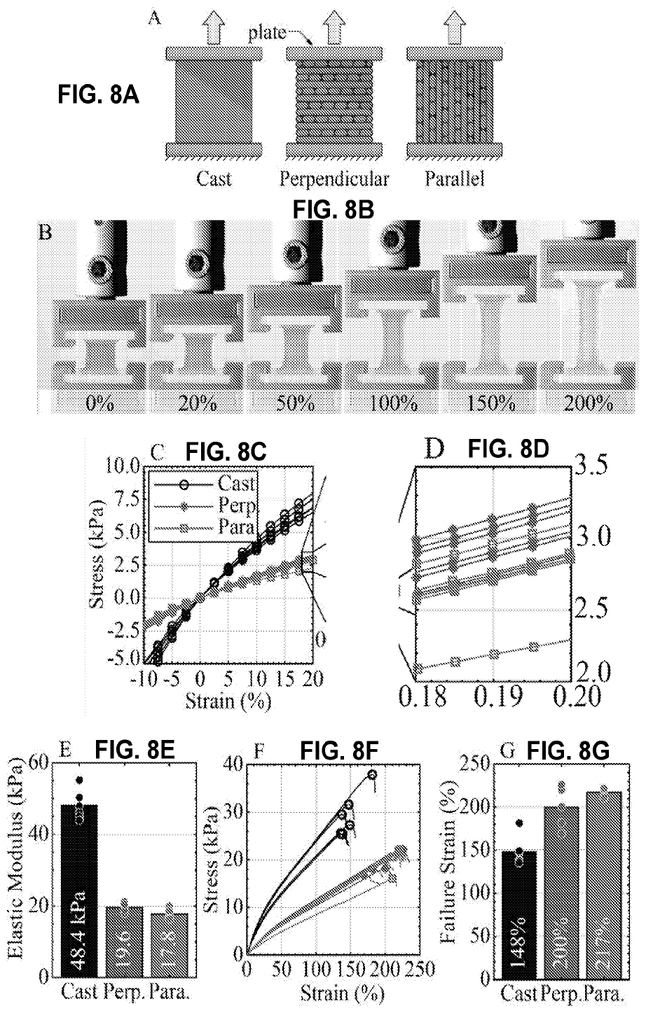

For the tensile tests, half of the printed cubes were oriented as printed with their layers perpendicular to the force direction (“perpendicular-printed cubes”) and half were rotated so their layers were parallel with the force (“parallel-printed cubes”). FIG. 8A shows the setup and orientation of the cast and printed cubes during tensile testing. The printed specimens were tested in these two orientations to measure the effect of layer orientation on the cured elastic modulus. Before testing, each cube was glued between two acrylic plates using a silicone adhesive (SilPoxy, Smooth-On).

Tensile testing was performed on a uniaxial tensile tester (Instron 3348) fitted with custom mounts to hold the acrylic plates. FIG. 8B shows several instances during tensile testing of a perpendicular-printed cube, labeled with percent strain. FIG. 8C is a graph showing engineering stress plotted from −10 to +20% strain for all 18 cube specimens (six samples for each specimen type: cast, perpendicular-printed, parallel-printed). Markers are placed every five data points. Precyclying was performed on each specimen for 10 cycles at a rate of 100 mm/min between −10% and +25% tensile strain. Next, a tensile load was applied at a rate of 30 mm/min until failure. Engineering stress-strain data were calculated for each specimen, and a second-order polynomial fit was applied to the data between ±10% strain. Elastic modulus was calculated as the tangent modulus at 0% strain. Failure strain was calculated as the strain at which the stress was maximum.

Support Matrix Rheological Tests

To characterize the rheological properties of the support matrix, measurements were performed on a rotational rheometer (AR2000-ex, TA Instruments) using a stainless steel, sandblasted 40 mm parallel upper plate (519400.901, TA Instruments) and a lower Peltier plate with a gap of 1000 μm. The lower plate was roughened by applying adhesive-backed sandpaper to the surface (extra fine 320 grit, Gator Power) and was temperature-controlled at 20° C. for all tests.

All rheological tests began by pre-shearing the support matrix sample at a rate of 10 s⁻¹ for 30 s then equilibrating at zero shear for 60 s to remove loading history and allow the structure to rebuild to its steady state. The dynamic yield stress and shear thinning viscosity of the support matrix were measured by decreasing shear rate from 500 to 0.01 s⁻¹ in 60 s and fitting the data to a Herschel-Bulkley model.

Thixotropic response was measured by running a 3-Interval Thixotropy Test at shear rates of 0.1 and 46 s⁻¹ (calculation of this high shear rate is provided in Supporting Information). Thixotropic recovery time was measured as the time required for the sample viscosity to recover to 95% of its rest viscosity.

Support Matrix Curing Tests

To determine if support matrix material remained inside the print during the printing and curing processes, a cube was printed from a clear silicone ink (i.e., as described in above, without pigment) into a support matrix containing a dispersion of copper particles (nanopowder, <100 nm BET, CAS #7440-50-8). This was done so any trapped matrix material could be identified within the otherwise clear silicone print. To help with identification, the mid-section of the cube printed into the copper-filled matrix was compared with the mid-section of a cube printed from the same clear ink into an unmodified support matrix.

To determine if the support matrix material cured within the print, the mid-sections of printed and cured specimens were observed under microscope to identify any indications of trapped uncured support matrix material or print patterns (i.e., if layers or paths were visible). The mid-sections of printed specimens were also compared with mid-sections of cast specimens to identify any differences in material homogeneity that could have been a result of printing. Mid-sections were obtained by cutting specimens into three roughly-equal sections (parallel with the cube's front face, see FIG. 7B) with scissors and using the middle section. The fracture patterns of specimens subjected to tensile testing were also observed to determine if any print artifacts could be observed in the broken sections of the printed cubes.

Tensile Testing Results

As noted above, FIG. 8C shows engineering stress plotted from −10 to +20% strain for all 18 cube specimens (six samples for each specimen type: cast, perpendicular-printed, parallel-printed), with markers are placed every five data points. FIG. 8D is a detailed view of FIG. 8C from 18 to 20% strain showing the spread between the stress-strain curves for perpendicular- and parallel-printed specimens, with markers are placed at each data point. FIG. 8E shows the elastic modulus for each specimen type, with columns showing average modulus and markers showing individual specimens. FIG. 8F shows engineering stress vs. engineering strain curves for all 18 cube specimens, with markers placed at the failure strain of each specimen. FIG. 8G shows the failure strain for each specimen type, with the columns showing average failure strain and the markers show individual specimens.

Tensile test results showed that printing within the selectively-curable support matrix resulted in average elastic moduli of 48.4, 19.6, and 17.8 kPa for cast, perpendicular-printed, and parallel-printed cubes, respectively. These average elastic moduli values indicate that the printing process decreased the modulus to 40% in the perpendicular direction and 37% in the parallel direction with respect to the cast modulus. Due to the similarity in modulus of the perpendicular-printed and parallel-printed specimens, the decrease in modulus is likely not due to their layer-upon-layer fabrication as has been commonly observed in 3D printed parts. Instead, this decrease in modulus is likely due to a higher concentration of Silicone Thinner (which decreases the elastic modulus when added to silicone) within the print due to the presence of support matrix material within the printed structure. Some decrease in elastic modulus was not unexpected for the printed cubes since the test specimens were printed at 60% infill. As will be shown, the support matrix material cured within the printed structure, thus resulting in the printed cubes having a lower average elastic modulus than their cast counterparts but higher than when printing into support matrix that did not cure.

The tensile test results were compared to other comparison samples using the same silicone ink, mixing ratio, and tensile testing procedure to determine how printing in our support matrix affected the tensile properties of silicone. The other comparison samples included printed cube specimens within a micro-organogel support matrix that was formulated for printing silicone, while the sample according to this disclosure included specimens printed within the selectively-curable support matrix described above. For 1 cm cube specimens printed within the micro-organogel support matrix, the other comparison samples had an average elastic modulus (using engineering stress) of 30.4 kPa, 5.2 kPa, and 11.0 kPa for cast, perpendicular-printed, and parallel-printed cube specimens. Printing within the micro-organogel support matrix decreased the modulus in the perpendicular and parallel directions to 17% and 36%, respectively, of the cast modulus. The decrease in modulus was a result of uncured support material between print paths and layers.

In comparing the samples according to this disclosure to the other comparison samples, it was discovered that that printing silicone within the selectively-curable support matrix results in prints with more material isotropy and a higher relative stiffness in the perpendicular orientation. These results that the unique properties of the selectively-curable support matrix help mitigate some problems previously observed when 3D printing silicone, including the poor adhesion between print paths and layers. Furthermore, it is evident that the decrease in modulus when printing within the selectively-curable support matrix is a result of a higher concentration of Silicone Thinner rather than because of uncured material within the prints.

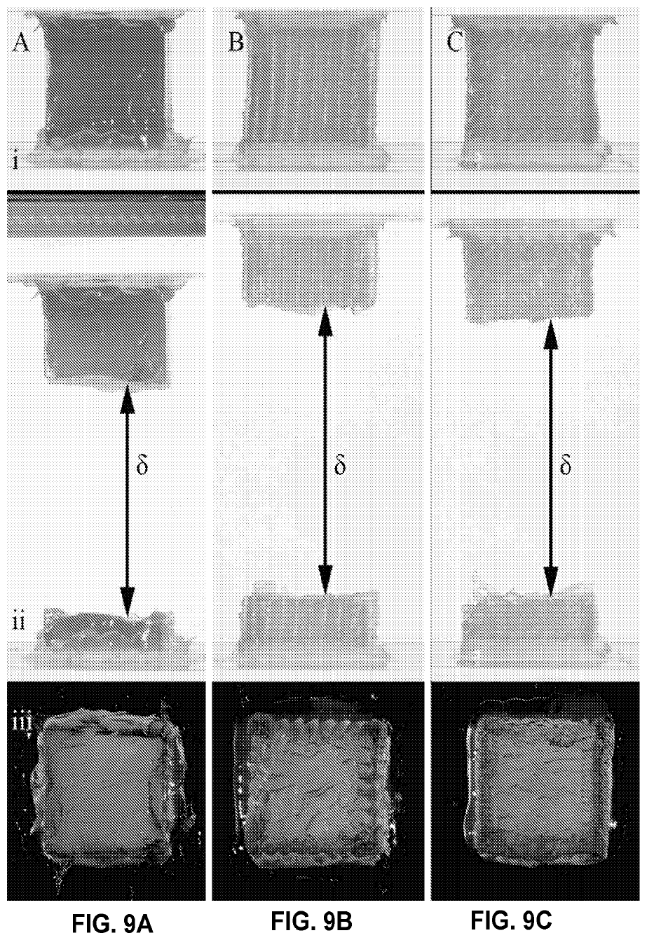

The failure strain of the printed and cast specimens also provides evidence that the selectively-curable support matrix increased material adhesion between paths and layers beyond that which resulted with the micro-organogel support matrix. The failure strain, found at the location of maximum stress, was on average 148% for cast specimens, 200% for perpendicular-printed specimens, and 217% for parallel-printed specimens (see FIG. 8). FIG. 9A-9C also provides images of cube specimens during and after tensile testing. Specifically, FIG. 9A are images of a cast specimen, FIG. 9B are images of a perpendicular-printed specimen, and FIG. 9C are images of a parallel-printed specimen. The rows of FIG. 9A-9C include: i) images showing the specimens at 0% strain, ii) images acquired just after the failure of each specimen during tensile testing, and iii) images showing the inner face of the specimens (bottom half) after failure. The distance, δ, between the top and bottom sections in row ii of FIGS. 9A-9C shows the distance that each specimen stretched during testing.

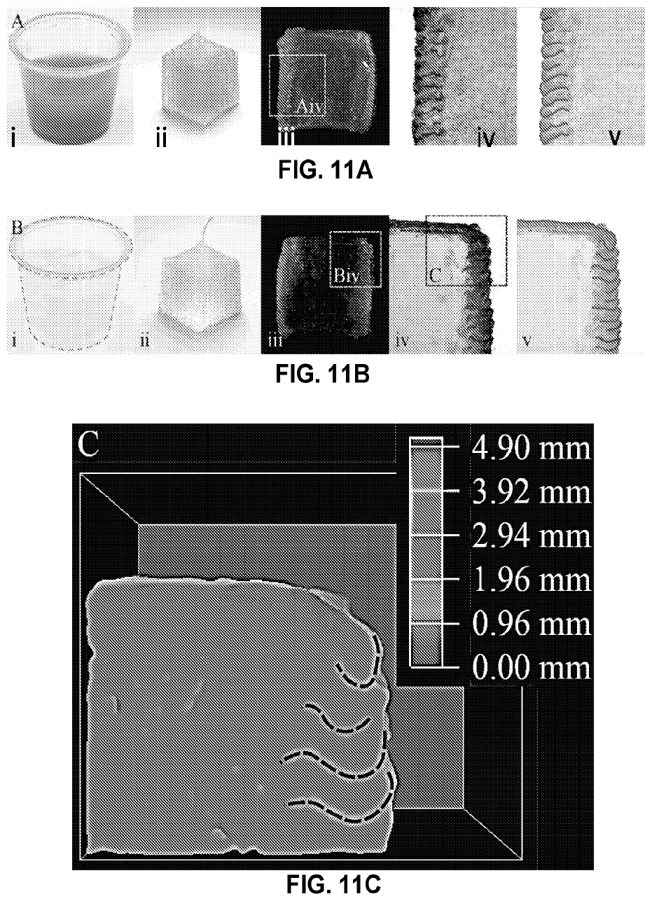

The fracture patterns of printed and cast cubes after tensile testing were imaged under microscope. No evidence of layers or paths could be observed within the fractured faces. The edges of the layers, however, could be observed in the fractured parallel-printed specimen (see FIG. 9B, row iii) similar to the edges observed in section prints (see FIG. 11A and FIG. 11B, columns iv and v). These edge defects may have contributed to the lower failure strain for perpendicular-printed cubes.

These results indicate printing does not decrease the ultimate elongation of the printed silicone. It was observed that printing within the selectively-curable support matrix allows prints to undergo significantly greater amounts of strain before failure.

Support Matrix Rheology

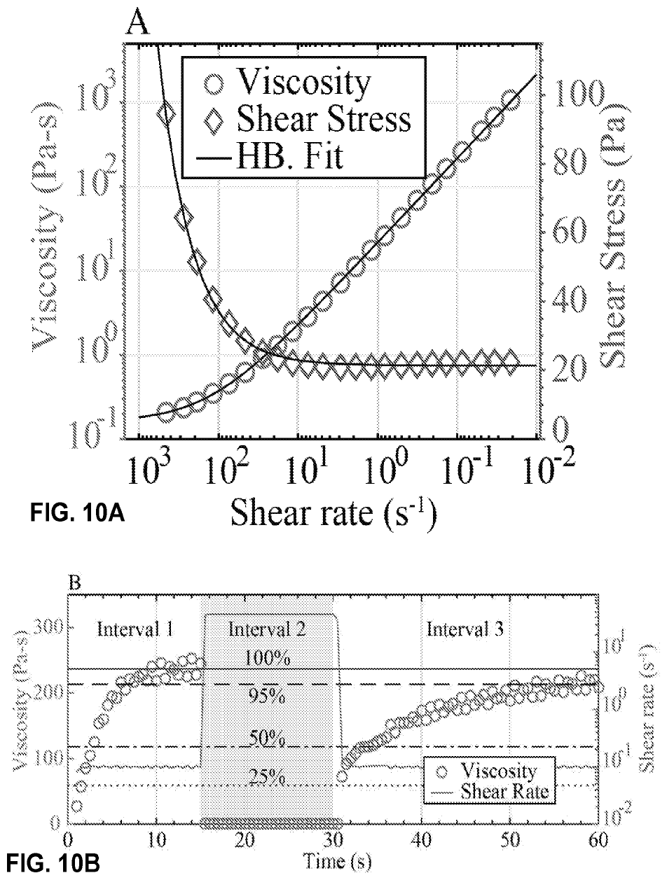

The shear-thinning viscosity and dynamic yield stress of the support matrix was characterized by fitting a classic Herschel-Bulkley model to the test data. FIGS. 10A-10B are graphs characterizing the support matrix rheology. FIG. 10A shows the viscosity (circular markers, left y-axis) and shear stress (diamond markers, right y-axis) when linearly decreasing shear rate from 500 to 0.1 s⁻¹ to measure the dynamic yield stress and shear thinning viscosity of the support matrix. Shear rate decreases along the x-axis to emphasize that measurement was performed while decreasing shear rate. A Herschel-Bulkley curve was fit to the data to quantify both the shear-thinning viscosity and yield stress. FIG. 10B shows the 3-Interval Thixotropy Test used to determine the thixotropic recovery time of the support matrix. Viscosity (circular markers, left y-axis) of the support matrix is plotted in response to a shear rate command (solid line, right y-axis) during three intervals. The first and third intervals simulate the material at rest with a low shear rate (0.1 s⁻¹), whereas the second interval simulates the shear during printing (46 s⁻¹; calculation of this value in Supporting Information). Thixotropic recovery time is measured as the time required for the viscosity to reach 95% of the rest viscosity on unloading (transition between intervals 2 and 3).

Parameters for the model included a dynamic yield stress of 21.4 Pa, a viscosity index of 0.153 Pa·s, a rate index of 1.01, and a standard error of 8.42. The calculated dynamic yield stress (21.4 Pa), or the minimum stress required to maintain flow, is higher than that which was measured for a micro-organogel support matrix (4 Pa), and lower than for an optimized support matrix made from Carbopol (70 Pa), both of which were used for printing silicone.

The Herschel-Bulkley model parameters reported above also characterized the shear-thinning viscosity, showing that the viscosity decreased approximately one decade for each decade increase in shear rate (rate index: 1.01). Reports of other removable-embedded 3D printing processes for silicone do not include descriptions of shear-thinning behavior for their respective support matrices. Reports of embedded 3D printing processes, however, do indicate that their support matrices have shear-thinning viscosities. This similarity was not surprising, as the matrices contain the same rheological modifier (fumed silica).

Results from the 3-Interval Thixotropy Test showed that the support matrix fluidized to a low viscosity within 1 second on loading due to the shear-thinning viscosity (transition between intervals 1 and 2, FIG. 10B). On unloading (transition between intervals 2 and 3), the support matrix took approximately 25 s to recover 95% of the rest viscosity.

Evaluation of Support Matrix Curing

Printing a clear silicone ink into a support matrix infiltrated with copper nanoparticles showed that a noticeable amount of support material remained dispersed inside the cured print. FIG. 11A is photographs of the mid-sections of cubes printed into a support matrix having a dispersion of copper particles. FIG. 11B is photographs of the mid-sections of cubes printed into an unmodified support matrix. The columns of FIGS. 11A-11B include: i) support matrices used for printing, with dashed lines in (FIG. 11B, column i) showing edges of the reservoir; ii) cured cubes which were printed from the same unpigmented (i.e., clear) silicone into their respective support matrix (FIG. 11A or 11B); iii) microscope images of the cube mid-section on a darkened background, with an apparent yellow tint on edges a result of lighting setup, and coloring of mid-section in FIG. 11A, column iii being distinctly copper-colored; iv) magnified, multi-focus images with a light source behind the mid-sections, the speckles observed in FIG. 11A, column iv showing the presence of trapped copper particles indicating that the support matrix remained trapped within the cured print, the few speckles observed in FIG. 11B, column iv likely being due to defects in the material; and v) semi-transparent images with edges marked with dashed lines showing evidence of print layers. FIG. 11C includes a 3D scan from multi-focus imaging. Lines in FIG. 11A, column v, and FIG. 11B, column v, and dashed black lines in FIG. 11C have been added to approximately denote regions of apparent separation between layers on the edge.

While the distribution of particles was expected to resemble the interstices between layers and paths of the print, the particles instead appeared to be evenly distributed, suggesting that the support matrix material may have mixed with the extruded ink. This mixing is expected to have increased material adhesion within the print and decreased the elastic modulus of the material (as was discussed in above). The inside faces of sectioned prints observed under a microscope appeared generally similar to those of cast cubes, with no observable voids or uncured material within the print.

Print Performance

A set of print settings (discussed above) were identified through iteration that resulted in high-quality prints. This iteration process was simplified because the support matrix could remain inside the ink structure for support during printing and then cure within the printed paths and layers. This curing property enabled material adhesion within the print without requiring parameter overrides to overlap layers or paths, as has been used in other works. It was surprisingly discovered that the best print performance for solid-infill shapes occurred at 60% infill (see Table 1). It was also found that some deviations from these settings (e.g., changing infill angle) did not cause a noticeable reduction in print quality.

Printed cube specimens were on average between 0.25 and 1 mm larger in width, depth, and height from the dimensions of the STL model (10×10×10 mm). This deviation in print geometry is likely due to a combination of factors including the relatively slow thixotropic recovery time of the support matrix, printer setup and design, possible extrusion imprecision, and the movement resolution of the CNC motors. Print time for each cube specimen was 8 minutes 26 seconds, which is comparable to common FDM 3D printers.

### Working Example 2

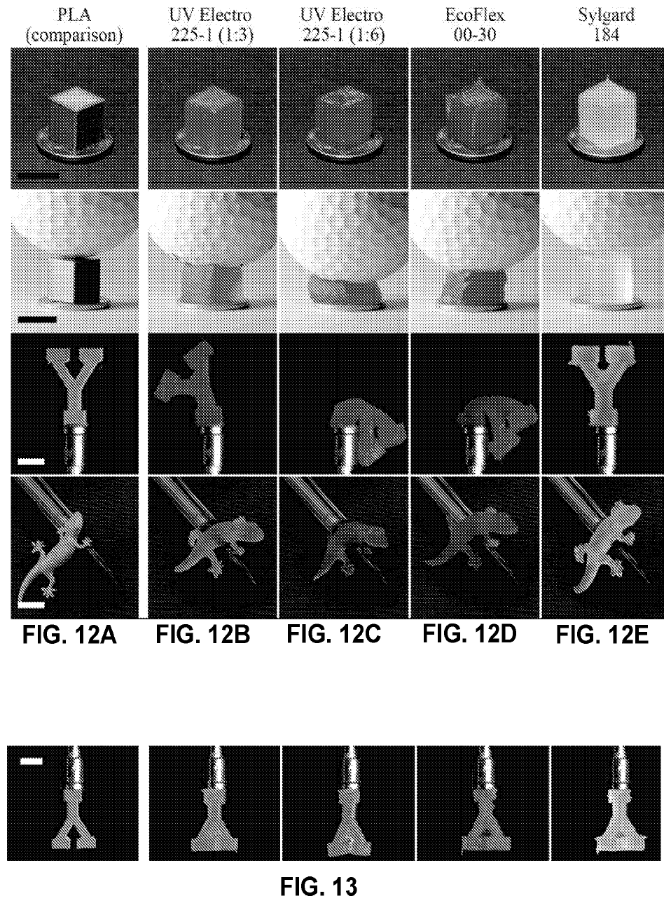

To further explore the capability and versatility of the selectively-curable support matrix and printing setup, a variety of demonstration prints from UV and addition-cure silicone elastomers were produced. The demonstration prints were compared to shapes printed using PLA on an FDM 3D printer (Original Prusa I3 MK3S). The elastic modulus and elongation at break of printed cube specimens were tested using the process described in above (“Cured Print Tensile Tests”). Photographs of the prints are shown in FIGS. 12A-12E, in which the geometry and apparent stiffness of each is evident. FIGS. 12B-12E are images prints fabricated from four silicone inks) compared to photographs of similar shapes printed from PLA using an FDM 3D printer FIG. 12A. Material abbreviations are described in Table 2. Cubes were printed, placed on a U.S. penny in row 1 of FIGS. 12A-12E, and compressed by the weight of a golf ball (approx. 45 g) to demonstrate the stiffness of each material in row 2 of FIGS. 12A-12E. Other geometries including a ‘Y’ in row 3 of FIGS. 12A-12E and a gecko in row 4 of FIGS. 12A-12E further exemplify material stiffness. The base of each ‘Y’ was glued to a magnet before imaging in row 3 of FIGS. 12A-12E. Geckos were placed near the tip of a mechanical pencil for imaging. All demonstration prints were fabricated using the same set of print settings and printed into the same support matrix formulation. The size of the geometries are as follows: cubes in row 1 of FIGS. 12A-12E are 1×1×1 cm, the ‘Y’ in row 3 of FIGS. 12A-12E is 2.5 cm in height and 0.95 in depth, the gecko in row 4 of FIGS. 12A-12E is 4 cm in length. Length of each scale bar is 1 cm.

The shear rate \dot{γ} around the needle during printing was found to be approximately 46 s⁻¹ using the needle's outer diameter d (0.52 mm) and the print velocity

$$v ( \dot{γ} = \frac{v}{d} ) . \qquad [ 42 ]$$

Using this shear rate, the viscosity around the translating needle was calculated to be approximately 0.65 Pa·s. This low viscosity helped the support matrix to flow around the needle, reduced drag and deflection of the needle, and minimized dynamic crevasses.

TABLE 2
Material properties of mixed and printed silicone inks used for
demonstration prints.

| | | | | | | Printed | |
|---|---|---|---|---|---|---|---|
| | | | | | Uncured | cured | Failure |
| | | Curing | | | viscosity | stiffness | strain |
| Abbreviation | Color | method | Material | Mixing ratio (by weight) | [Pa · s] | [kPa] | [%] |
| M1:3 | Light Blue^{a)} | UV | Momentive | 1:3 (base + catalyst:Thinner) | 0.373 | 20.0 | 180 |
| | | | UV Electro | | | | |
| | | | 225-1 | | | | |
| M1:6 | Dark Blue^{a)} | UV | Momentive | 1:6 (base + catalyst:Thinner) | Not | 5.3 | 198 |
| | | | UV Electro | | tested^{d)} | | |
| | | | 225-1 | | | | |
| EF30 | Green^{a)} | Addition | EcoFlex | 1:1 (part A:part B) | 3.0^{c)} | 15.2 | 260 |
| | | | 00-30 | | | | |
| S184 | Translucent^{b)} | Addition | Sylgard | 10:1 (base:catalyst) | 3.5^{c)} | 430.3 | 47 |
| | | | 184 | | | | |

^{a)}Pigmented;
^{b)}Unpigmented;
^{c)}Information from their respective datasheets;
^{d)}Qualitatively appeared less viscous than M1:3.

Four silicone elastomer inks were chosen that differed in curing method and ranged in uncured viscosity and cured stiffness. The first two inks were mixtures of Momentive UV Electro 225-1, the same UV-curable silicone used in other parts of this work. The first was mixed at the same ratio as described in Section 2.2 (1:3, base+catalyst:Thinner) and the second at a higher ratio (1:6) for lower-stiffness prints. The third ink was made from the addition-cure silicone EcoFlex 00-30 (SmoothOn), chosen for demonstration because it has a low stiffness, is commercially available at a relatively low cost, and is commonly used in soft robotics, soft sensors, and biomechanics studies. Sylgard 184 (Dow Corning), a high-stiffness addition-cure silicone, was selected as the fourth ink because it is also widely used in many applications. EcoFlex 00-30 and Sylgard 184 were prepared as described in their respective datasheets.

The geometries of demonstration prints were selected to explore the capabilities of the printer and demonstrated the curing and supporting properties of the selectively-curable support matrix. Selected geometries included thick sections to highlight the curing properties of the support matrix, overhangs to demonstrate the support capabilities and the apparent stiffness of each material, and features near the spatial resolution of the printer's motors and nozzle diameter (ID of needle) to show the ability of the matrix to preserve intricate features during printing and curing.

The printing process, support matrix, and print settings were kept constant for all demonstration prints to enable comparison between the geometry and stiffness of shapes printed from the different silicone inks. Each demonstration print was printed into the support matrix formulation as described above (“Support Matrix Preparation”). Print settings used to create the G-code for each shape were the same as described above (“Print Settings & Performance”) and Table 1, with the exception that a single perimeter wall was also printed around each layer's infill. The infill overlap parameter was set to −10%, and the perimeter was printed after the infill for each layer.

Tensile testing (see Table 2) showed that the printing process was capable of fabricating shapes with a wide range of cured material properties. For example, the stiffness of the cube specimens printed with the different inks ranged between 5.3 and 430 kPa. The elongation at break of the specimens ranged between 47 and 260%.

The geometries of the demonstration prints were close to the desired geometry. Some apparent defects, visible in FIGS. 12A-12E, were a result of the low material stiffness rather than from printing. Because the extruder setup was not capable of retraction, material between the arms of the ‘Y’ was trimmed. In FIG. 13, photographs of the shapes before trimming are shown. The material was trimmed because the extruder was unable to perform retraction, which resulted in a thin section of extra material between the arms of the ‘Y’. Each print is 2.5 cm tall. Images were captured with prints oriented upside-down (i.e., as shown), with a scale bar length of 1 cm.

The successful fabrication of these demonstration prints in Example 2 highlights the overall success of the printing process and selectively-curable support matrix and illuminates their potential in a variety of relevant fields. The solid infill and complex geometries of the cured prints showed that the matrix could support the four different UV and addition-cure silicone inks and that the matrix was curable within each ink. Other silicone inks also could be printed with similar results. In an undeformed state, the geometric accuracy of the demonstration prints was close to the desired geometry, Furthermore, tensile test results showed that the printing process and support matrix are capable of fabricating silicone shapes with a wide range of cured material properties. This capability may be leveraged to fabricate novel silicone devices.

Some embodiments described herein include a selectively-curable support matrix for removable-embedded 3D printing of silicone elastomers configured that create solid-infill prints from a UV-curable silicone. As described above, the stiffness and elongation at break for cast and printed cubes were determined by tensile testing and these results were compared to cubes printed within a comparable support matrix. The rheological properties of the support matrix were tested and compared to similar support matrices. The curing property of the support matrix was tested by observing the mid-sections of printed cubes. Additionally, various solid-infill shapes were printed from four UV and addition-cure silicone inks to demonstrate the ability of the printing process and support matrix to print inks from a range of uncured viscosities and that resulted in a very wide range of cured material stiffnesses.

Print results indicated that the selectively-curable support matrix supported the low-viscosity ink during printing and solidified within the deposited paths and layers during the curing process. The support matrix provided support to the liquid ink structure during printing by acting like a solid at rest, temporarily fluidizing around the translating needle, then returning to a solid-like state once the needle had passed. Rheological test results support this claim by showing that the support matrix had a shear-thinning viscosity and a low dynamic yield stress.

Because of the supporting and curing properties of the selectively-curable support matrix, the removable-embedded printing process described herein has several advantages over similar processes. The material similarity between the support matrix and ink improves print quality and allowed the matrix to be selectively cured within the printed structure. The curing property of the support matrix, which was verified by examining the mid-sections of printed specimens, effectively eliminates the undesirable effects of uncured support matrix material trapped within prints. Because of this, printing within the selectively-curable support matrix enables strong material adhesion between ink paths and layers without the need to overlap layers or optimize support matrix rheology, which has generally been the approach of prior works. Thus, many embodiments of the presently-described printing process can be implemented using commonly-available slicing programs and with a range of print settings.

The printing process described herein also has several advantages over direct ink writing and embedded 3D printing. For example, because inks used in direct ink writing processes must be self-supporting (i.e., with a relatively high viscosity at rest), these processes often require higher extrusion forces. If the chosen ink has a low rest viscosity, the ink may be modified to be self-supporting by adding filler particles. Adding particles, however, complicates ink preparation and alters the material properties of the cured material (e.g., increased modulus, altered optical properties) which may be undesirable. The presently-described printing process, on the other hand, does not require inks to be self-supporting (due to the support matrix) and can print a wide range of silicone inks, including unmodified low viscosity inks as well as inks with fillers and other small particles. Furthermore, printing within a support matrix enables the creation of geometries not possible using direct ink writing (where, for example, support is required for overhangs) or embedded 3D printing (where print geometry is constrained by the geometry of the reservoir).

Tensile test results provided herein show that printed cube specimens were generally isotropic, exhibiting similar stiffnesses when pulled perpendicular and parallel to the printed layer orientation. The stiffness of printed specimens was lower than that of cast specimens, which could be desirable for some applications. If increased final stiffness were to be desired, prints could be made with a different ink, as shown in the Example 2 prints above. Another possible way to increase the printed material's cured stiffness would be to incorporate filler particles into the ink or support matrix. For example, fumed silica (the rheological modifier used in the support matrix) is can be used to increase the stiffness of silicone. Adding fumed silica into the ink or possibly increasing its concentration in the support matrix could also increase the cured stiffness of prints. Supporting and curing capabilities also can be expanded to other ink-matrix material formulations such as with urethanes, hydrogels, and organic microgel systems.

Tensile test results also showed that printed cube specimens could be stretched to high amounts of strain before failure. This finding provides further evidence of the strong material adhesion within the printed volume and suggests the potential application of this printing process in many fields of research such as for fabricating soft robotics and stretchable electronics, which often require materials to withstand high levels of strain before failure. The ability of the print process to fabricate ultra-low-stiffness silicone could also be leveraged in many applications; one example is the fabrication of self-oscillating synthetic models of human vocal folds.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

What is claimed is:

1. A method of printing a three-dimensional object, the method comprising:
providing a reservoir including a support matrix therein;
depositing at least one ink having at least one catalyst and a cross-linker into the support matrix in the reservoir in a predetermined pattern effective to form a plurality of layers of the at least one ink, wherein the support matrix supports the plurality of layers of the at least one ink deposited therein and one or more portions of the support matrix are disposed between at least two layers of the plurality of layers of the at least one ink when the plurality of layers of the at least one ink are formed in the support matrix; and
at least partially solidifying the at least one ink deposited into the support matrix and the one or more portions of the support matrix disposed between the at least two layers of the plurality of layers of the at least one ink to form the three-dimensional object, wherein the at least one catalyst and the cross-linker in the at least one ink promote bonding between the at least one ink and the one or more portions of the support matrix disposed between the at least two layers of the plurality of layers of the at least one ink.

2. The method of claim 1, further comprising:
preparing the support matrix by mixing a liquid with a thickener; and
inserting the support matrix into the reservoir.

3. The method of claim 2, wherein the liquid of the support matrix includes a base polymer and the at least one ink includes the base polymer.

4. The method of claim 2, wherein preparing the support matrix by mixing the liquid with the thickener includes preparing the support matrix by mixing silicone oil with the thickener that includes fumed silica, and wherein the at least one ink includes a silicone ink including the at least one catalyst and the cross-linker.

5. The method of claim 1, wherein depositing the at least one ink into the support matrix in the predetermined pattern includes extruding the at least one ink through a needle as the needle translates through the support matrix in the predetermined pattern that forms the plurality of layers of the at least one ink.

6. The method of claim 1, wherein at least partially solidifying the at least one ink deposited into the support matrix includes at least partially curing the at least one ink deposited into the support matrix.

7. The method of claim 6, wherein at least partially curing the at least one ink deposited into the support matrix includes ultraviolet curing the at least one ink deposited into the support matrix.

8. The method of claim 1, further comprising:
removing at least a portion of the three-dimensional object from the support matrix; and
depositing additional ink into the support matrix after removing the three-dimensional object from the support matrix to reuse the support matrix.

9. A system for printing three-dimensional objects, the system including:
one or more first reservoirs including at least one ink, at least one catalyst, and a cross-linker;
a second reservoir including a support matrix configured to support the at least one ink including the at least one catalyst and the cross-linker when the at least one ink is deposited into the support matrix;
a printer configured to inject the at least one ink including the at least one catalyst and the cross-linker into the support matrix held in the second reservoir in a predetermined pattern effective to form a plurality of layers of the at least one ink, wherein one or more portions of the support matrix are disposed between at least two layers of the plurality of layers of the at least one ink when the plurality of layers of the at least one ink are formed in the support matrix; and
a solidifying system configured to at least partially solidify the at least one ink deposited into the support matrix, wherein the at least one catalyst and the cross-linker in the at least one ink promote bonding between the at least one ink and the one or more portions of the support matrix trapped between the at least two layers of the plurality of layers of the at least one ink to solidify the one or more portions of the matrix.

10. The system of claim 9, wherein the at least one ink includes a base polymer and the support matrix includes the base polymer.

11. The system of claim 10, wherein the support matrix includes a liquid and a thickener.

12. The system of claim 9, wherein the support matrix includes silicone oil, the thickener in the support matrix includes fumed silica, and the at least one ink includes a silicone ink including the at least one catalyst and the cross-linker.

13. The system of claim 9, wherein the printer includes a needle configured to extrude the at least one ink therethrough as the needle translates through the support matrix in the predetermined pattern.

14. The system of claim 9, wherein the solidifying system includes a curing system configured to at least partially cure the at least one ink deposited into the support matrix.

15. The system of claim 14, wherein the curing system includes an ultraviolet light configured to be positioned outside the second reservoir and at least partially cure the at least one ink deposited into the support matrix.

16. A method of printing a three-dimensional object, the method comprising:
providing a support matrix having a base component;
depositing at least one ink having the base component, at least one catalyst and a cross-linker into the support matrix in a predetermined pattern effective to form a plurality of layers of the at least one ink, wherein the support matrix supports the plurality of layers of the at least one ink deposited therein and one or more portions of the support matrix are disposed between at least two layers of the plurality of layers of the at least one ink when the plurality of layers of the at least one ink are formed in the support matrix; and
at least partially solidifying the at least one ink deposited into the support matrix and the one or more portions of the support matrix disposed between the at least two layers of the plurality of layers of the at least one ink to form the three-dimensional object, wherein the at least one catalyst and the cross-linker in the at least one ink promote bonding between the at least one ink and the one or more portions of the support matrix disposed between the at least two layers of the plurality of layers of the at least one ink.

17. The method of claim 16, further comprising preparing the support matrix by mixing a liquid including the base component with a thickener, wherein the base component includes a base polymer.

18. The method of claim 16, wherein at least partially solidifying the at least one ink deposited into the support matrix includes at least partially curing the at least one ink deposited into the support matrix.

19. The method of claim 16, wherein at least partially curing the at least one ink deposited into the support matrix includes ultraviolet curing the at least one ink deposited into the support matrix.

20. The method of claim 16, further comprising:
removing the three-dimensional object from the support matrix; and
depositing additional ink into the support matrix after removing the three-dimensional object from the support matrix to reuse to the support matrix.

21. A method of forming a three-dimensional object, the method comprising:
providing a reservoir including a support matrix therein;
depositing at least one material in the support matrix in the reservoir in a predetermined pattern effective to form a plurality of layers of the at least one material, wherein the support matrix supports the plurality of layers of the at least one material deposited therein and one or more portions of the support matrix are disposed between at least two layers of the plurality of layers of the at least one materials when the plurality of layers of the at least one material are formed in the support matrix; and
at least partially solidifying the at least one material deposited into the support matrix and the one or more portions of the support matrix disposed between the at least two layers of the plurality of layers of the at least one material to form the three-dimensional object.

22. The method of claim 21, wherein at least partially solidifying the at least one material deposited into the support matrix and the one or more portions of the support matrix disposed between the at least two layers of the plurality of layers of the at least one material includes:
simultaneously at least partially solidifying both the at least one material deposited into the support matrix and the one or more portions of the support matrix disposed between the at least two layers of the plurality of layers of the at least one material to form the three-dimensional object.

23. The method of claim 22, wherein simultaneously at least partially solidifying the at least one material deposited into the support matrix and the one or more portions of the support matrix disposed between the at least two layers of the plurality of layers of the at least one material includes:
simultaneously at least partially curing both the at least one material deposited into the support matrix and the one or more portions of the support matrix disposed between the at least two layers of the plurality of layers of the at least one material to form the three-dimensional object.

24. The method of claim 23, wherein the at least one material includes at least one cross-linker and at least one catalyst promote bonding between the at least one ink and the one or more portions of the support matrix disposed between the at least two layers of the plurality of layers of the at least one material when the at least one material is cured effective to simultaneously at least partially cure both the at least one material deposited into the support matrix and the one or more portions of the support matrix disposed between the at least two layers of the plurality of layers of the at least one material to form the three-dimensional object.

25. The method of claim 21, wherein at least partially solidifying the at least one material deposited into the support matrix and the one or more portions of the support matrix disposed between the at least two layers of the plurality of layers of the at least one material includes:
at least partially solidifying the at least one material deposited into the support matrix; and
at least partially solidifying the one or more portions of the support matrix disposed between the at least two layers of the plurality of layers of the at least one material after the at least one material deposited into the support matrix has been solidified.

26. The method of claim 25, wherein:
at least partially solidifying the at least one material deposited into the support matrix includes at least partially solidifying the at least one material deposited into the support matrix via a first process; and
at least partially solidifying the one or more portions of the support matrix disposed between the at least two layers of the plurality of layers of the at least one material after the at least one material deposited into the support matrix has been solidified includes at least partially solidifying the one or more portions of the support matrix disposed between the at least two layers of the plurality of layers of the at least one material via a second process that is different than the first process.

27. The method of claim 26, wherein the first process includes at least partially curing at a first light wavelength and the second process includes at least partially curing at a second light wavelength different than the first light wavelength.

28. The method of claim 26, wherein the first process includes at least partially solidifying at a first time period and the second process includes at least partially solidifying at a second time period that is different than the first time period.

29. The method of claim 26, wherein the first process includes at least partially solidifying at a first temperature and the second process includes at least partially solidifying at a second temperature that is different than the first temperature.

30. The method of claim 26, wherein the first process includes at least partially solidifying with at least one of a first light wavelength, a first time period, or a first temperature and the second process includes at least partially solidifying with at least one of a second light wavelength, a second time period, or a second temperature.

31. The method of claim 25, further comprising:
removing the at least one material from the support matrix after the at least one material has been at least partially solidified and before at least partially solidifying the one or more portions of the support matrix disposed between the at least two layers of the plurality of layers of the at least one material; and
depositing additional material into the support matrix after removing the at least one material from the support matrix to reuse to the support matrix.
